(19) United States
(12) Patent Application Publication
(10) Pub. No.: US 2007/0053279 A1
(43) Pub. Date: Mar. 8, 2007

(54) Multilayer fluorescent optical disc with photosensitive fluorescent material

(76) Inventors: Sergey Magnitskii, Moscow (RU); Dimitrij Pebalk, Moscow (RU); Dimitrij Malakhov, Moscow (RU); Vladimir Shubin, Moscow (RU); Jacob Malkin, Ashdod (IL); Eugene Levich, Tel-Aviv (IL); Mark Alperovich, Ashdod (IL); Eugene Kapinus, Kiev (UA); Andrey Tarasishin, Moscow (RU); Nikolay Magnitskii, Moscow (RU)

Correspondence Address: WINSTON & STRAWN LLP;PATENT DEPARTMENT, 1700 K STREET, N.W., WASHINGTON, DC, 20006, US

(21) Appl. No.: 10/982,917

(22) Filed: Nov. 8, 2004

Related U.S. Application Data
(63) Continuation of application No. 09/616,970, filed on Jul. 14, 2000, now abandoned.
(60) Provisional application No. 60/144,020, filed on Jul. 15, 1999.

(51) Int. Cl. G11B 7/24

(52) U.S. Cl. 369/275.1

(57) ABSTRACT

A multilayer optical memory of WORM (write-once-read-many) type has photosensitive layers with fluorescent reading. The disc contains a transparent substrate and multiple information layers spatially divided from one another by polymer layers and assembled using adhesive layers. Information is stored in a photosensitive substance within spiral grooves. The photosensitive substance can be formed as a continuous layer or as discrete grooves on a non-photosensitive background. Various compositions for the photosensitive substance allow recording in by changing fluorescence bleaching or emitting, with threshold-type recording.

### REFERENCE TO RELATED APPLICATION

The present application claims the benefit of U.S. Provisional Application No. 60/144,020, filed Jul. 15, 1999, whose disclosure is hereby incorporated by reference in its entirety into the present disclosure.

### FIELD OF THE INVENTION

The present invention is directed to a multilayer information storage medium and more particularly to such a medium using a fluorescent material for WORM (write once, read many) operation.

### BACKGROUND OF THE INVENTION

Existing optical memory systems utilize two-dimensional data carriers with one or two information layers. Most of the previous technical solutions in optical data recording propose registering the changes in reflected laser radiation intensity in local regions (pits) of each information layer. These changes could be a consequence of interference effects on relief optical discs of the CD-ROM type, burning of holes in the metal film; dye bleaching, local melting of polycarbonate in the widely-used CD-R systems; change of reflection coefficient in phase-change systems, etc.

Three-dimensional, i.e. multilayer, optical storage systems provide comparatively higher storage and recording capacity. However, they impose specific limitations and requirements to the construction and features of recording media, ways of data recording and reading, especially in the depth of the recording media.

In the reflection mode every information layer of the multilayer optical media must possess a partly reflective coating. The use of such coatings reduces the intensity of both reading and reflected information beams because those beams must pass through the partly reflective coatings to the given information layer and back to the receiver.

Besides, due to their coherent nature, both beams are subject to hardly estimated diffraction and interference distortions on fragments (pits and grooves) of the information layers on their way.

Writing information onto a multilayer medium poses another problem in that the recording of an information bit in a certain microvolume of the medium is accompanied by a change of optical density along the path of the writing beam through the layers above the layer being written to and also by an uncontrollable weakening of the recording radiation intensity. Those problems can cause failures at reading.

For this reason the medium with single-photon photochemical photon-mode recording has not heretofore been suitable for volumetric memory. Two-photon photon-mode recording methods and the appropriate media have a number of advantages, but now are difficult to implement.

Heat-mode recording—media of magneto-optical or phase-change types have a threshold or other nonlinear response to the writing beam and thus can avoid the problem of degradation of layers above the layer being written to, but they operate in the reflection mode.

### SUMMARY OF THE INVENTION

We propose the multilayer photosensitive disc, having a transparent substrate and subsequently located information layers, spatially divided by polymer layers and assembled with the help of adhesive layers. For safety, the disc surface is covered by a lacquer layer.

Information is stored in a photosensitive substance within spiral grooves. Layers can be formed as continuous layers, or the fluorescing substance can fill only discrete grooves on a nonfluorescent background.

We propose a composition for a multilayer optical disc with fluorescent WORM layers.

Fluorescent WORM layers have nonlinear (preferably, threshold-like) response to the reading radiation intensity. At reading, the fluorescent signal i.e. its presence or absence, or change of intensity in the information pit is subject to detection.

Another subject of the invention is the optimization of thermal recording and single- or two-photon reading modes with consideration of temperature, time and spatial profile and partial erasing at reading by radiation source with the same wavelength.

Depending, on the composition, the recording is achieved by appearance of fluorescence or its bleaching in the formed information pit under recording radiation.

The invention is still further directed to a reading and writing mechanism for such a disc.

Multilayer fluorescent discs with fluorescent reading are preferable as they are free of partly-reflective coatings. Diffraction and interference distortions in this case are much less due to the non-coherent nature of fluorescent radiation, its longer wavelength in comparison to the reading laser wavelength, and the transparency and homogeneity (similar reflection coefficients of different layers) of the optical media upon the incident laser and the fluorescent radiations. Thus, multilayer fluorescent discs have some advantages in comparison to reflective discs.

For multilayer disks the rate of chemical reaction dependence on intensity in WORM media shall be quadratic or With the greater degree of non-linearity. Even more desirable if it has threshold character, i.e. the response intensity shall exceed the threshold intensity. Reading from fluorescent multilayer laser WORM disc requires less intensity of laser radiation, than the recording. For systems with threshold the reading intensity shall be less than the threshold intensity.

### BRIEF DESCRIPTION OF THE DRAWINGS

Preferred embodiments of the present invention will be set forth in detail below with reference to the drawings, which show the following:

FIG. 1. Typical dependence of relative fluorescent signal changing on incident radiation intensity

FIG. 2. The form of a “recorded” information pit in fluorescent WORM

FIG. 3. Typical theoretical eye pattern of fluorescent WORM relative RF signal.

FIG. 4. Power distribution (normalized to incident) on the last layer of fluorescent WORM at different absorption coefficients of information substance in grooves.

FIG. 5. Temperature distribution within the disc at recording in adjacent layer

FIG. 6. Creation of uniform heat profile at cooling the layer.

FIG. 7. Kinetics of the pit cooling in the information layer in cut perpendicular to the grooves.

FIG. 8. Kinetics of cooling of the pit in the information layer along the groove.

FIG. 9. Schematic diagram of fluorescent multilayer WORM disc.

FIG. 10. Flow chart of the technological process of fluorescent multilayer WORM disc manufacturing.

FIG. 11. Scheme of recording & reading device.

FIGS. 12A and 12B. Micro-photos of fluorescent grooves (FIG. 12A) and recorded pits (FIG. 12B).

### DETAILED DESCRIPTION OF THE PREFERRED EMBODIMENTS

Optical, recording can be implemented as photon-mode recording and heat-mode recording.

In a multilayer optical storage system, the recording radiation is absorbed in a certain microvolume within the recording medium. The medium has a threshold response on the recording radiation intensity.

A fluorescent multilayer WORM utilizes a multilayer polycarbonate disc with previously made cavities in the form of grooves, filled with fluorescent material, as data carrier.

Heat-mode fluorescent WORM with so-called energetic substances requires irreversible heat decrease (or increase) of the dye fluorescence under laser radiation. An optical system focuses the laser beam on the recorded layer. The dye absorbs powerful laser radiation and warps up to high temperatures, causing irreversible changes of its fluorescent characteristics—decreasing or increasing of the dye fluorescence. In multilayer system at recording, the light is simultaneously absorbed in the recorded layer, as well as in all other layers. Reading from a fluorescent multilayer laser WORM disc is implemented by a less intensive laser power than that required for recording. The reading and writing light beams can be of the same wavelength and can be supplied by the same laser driven at different powers, thus permitting a simplified reading and writing device, which will be described in detail below.

In reading, a focused laser beam excites fluorescence in the dye, which is registered by the detector. In this case the detector registers a change of fluorescent signal in the recorded spots.

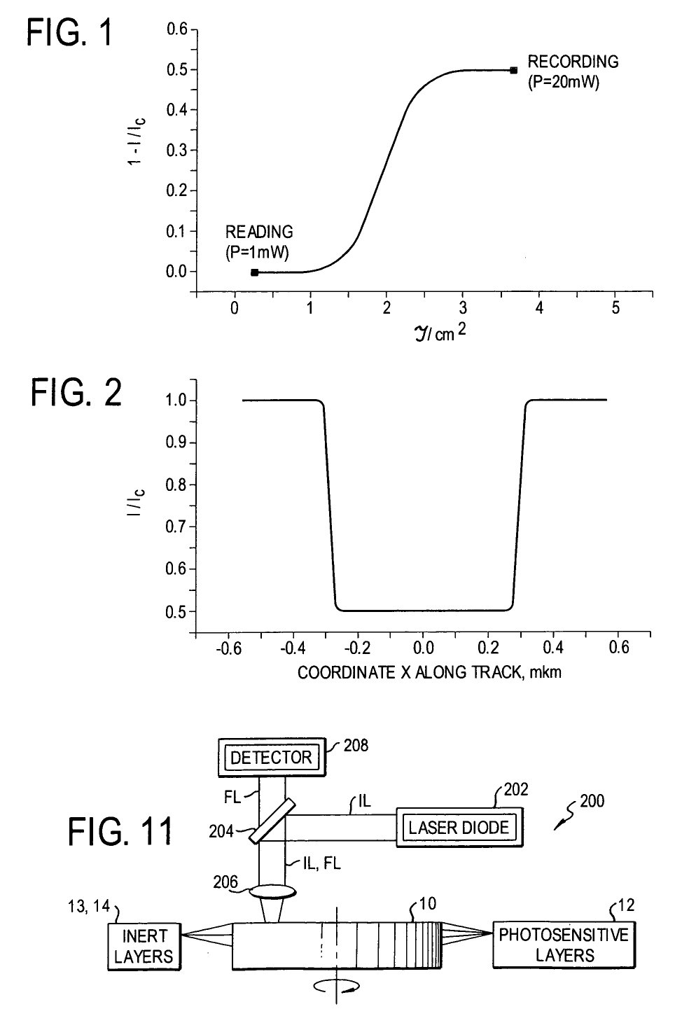

Thus, a non-linear fluorescence change dependent on the received radiation dose is a useful feature for realizing nondestructive reading and avoiding undesirable recording in adjacent layers of the multilayer system (see FIG. 1). Indeed, a fluorescent molecule's chemical reaction rate (recording rate) depends on temperature. During recording, the pit size is determined by the laser beam width. Typical time of the micro-pit thermal conductivity is measured in microseconds. Submicrosecond laser pulses produce the recording; therefore, heating of the material in the laser focus is local. Thus, maximum heating and, consequently, change of the dye fluorescence in the recorded zone totally depend on the laser beam power. The ideal ‘thermal’ WORM would then be made of an ‘absolutely nonlinear’ substance with stepwise changing susceptibility to temperature increase. In the real world non-linearity, defining WORM characteristics, is finite. The simulated non-linearity (FIG. 1) shows that a focused laser radiation of 1 mW power (reading) causes change of fluorescent signal equal to 5×10⁻⁵, while 20 mW radiation (recording)—to 0.5. Therefore, this system allows 10⁴ reading cycles.

The same estimation is made for undesirable recording on adjacent layers. The beam diameter on the adjacent layer depends on the focusing objective numerical aperture and the distance between the recorded and adjacent layer and is expressed by the following formula:

$$D / 2 = l \frac{NA}{\sqrt{1 - {NA}^{2}}} ,$$

where l is the distance between the studied and the recorded layer, NA is the objective numerical aperture. If NA=0.65 and l=350 μm, D=600 μm. In the DVD standard the focused beam diameter is equal to 1.2 μm, therefore the intensity on the adjacent layer will decrease in (D/D₀)²=(600/1.2)²=250000 times, and the interaction period will increase in (D/D₀)=600/1.2=500 times. Thus, the radiation dose, received during 1 turn on the adjacent layer, is 500 times lower than on the recorded layer. You can see on FIG. 2 that the change of fluorescent signal on the adjacent layer during 1 turn of the disc is equal to 10⁻⁵ of the initial fluorescent signal. Multiplying this number by 500 (number of disc turns while the certain spot on the disc surface is in the laser radiation zone) we get 5×10⁻³. Let us mark, that signal/noise ratio, corresponding to this volume (35 Db) sufficiently exceeds 20 Db, allowed by CD/DVD standard. In the common case, if fluorescence alteration is fixed in this standard as δ I_{f}=F(P), where P is the recording power, the fluorescence change on the adjacent layers during recording on the certain layer will be equal to:
δ I_{f}=nD/D₀F(PD₀/(nD)),
where n is number of the layer (counting from the recorded layer), D₀ is the beam diameter on the recorded layer. Thus, after recording in all layers of the disc the worst situation will arise on the central layer because it will be adjacent to two recorded layers. Its complete bleaching will be:

$$δ {I}_{f} = 2 {\sum }_{n = 1}^{M / 2} nD / {D}_{0} F ( {PD}_{0} / ( nD ) ) ,$$

where M is number of layers. Let us mark that this series is true if the non-linearity order is higher than second. In this case changing distance between layers allows reaching any high signal/noise ratio.

Size, shape and contrast of the recorded pit depend on the beam diameter, recording impulse power and non-linearity slope. See FIG. 2 for the results of numeric calculation for Bessel-shape beam in DVD standard with pulse duration 0.45 μs at 20 mW power for the material with non-linearity according to FIG. 1.

The calculations show excellent rectangular shape of signal from the pit, as good in quality as the one, received by molding technology in CD/DVD.

Reading from the fluorescent WORM is made by focusing the diode laser continuous radiation 1 mW into the groove with pre-recorded data pits, providing dye fluorescence modulation along the groove. The reading laser scans along the groove, causing dye fluorescence, while the detector registers modulation of fluorescent signal along the groove. Peculiarities of fluorescent reading are the following:
1. Fluorescent signal is shifted along the frequency spectrum in comparison to the exciting laser radiation, therefore it is not absorbed by the dye, which allows realizing multilayer systems;
2. Fluorescent light is non-coherent, i.e. it has random phase, therefore reading process responds exceptionally to signal amplitude in the contrary to CD/DVD, where the reading depends on the signal phase and so noise level in a multilayer system is high due to random phase incursion in every layer;
3. Fluorescence is emitted from the recorded pit uniformly in all directions, so that a gathering lens with big numerical aperture should preferably be used;
4. Multilayer fluorescent WORM has a nearly constant index of refraction in all displacement volume. It allows avoiding diffraction and dispersion effects as in CD/DVD.

Enclosed designed eye pattern shows fluorescent reading from fluorescent WORM with non-linearity according to FIG. 1.

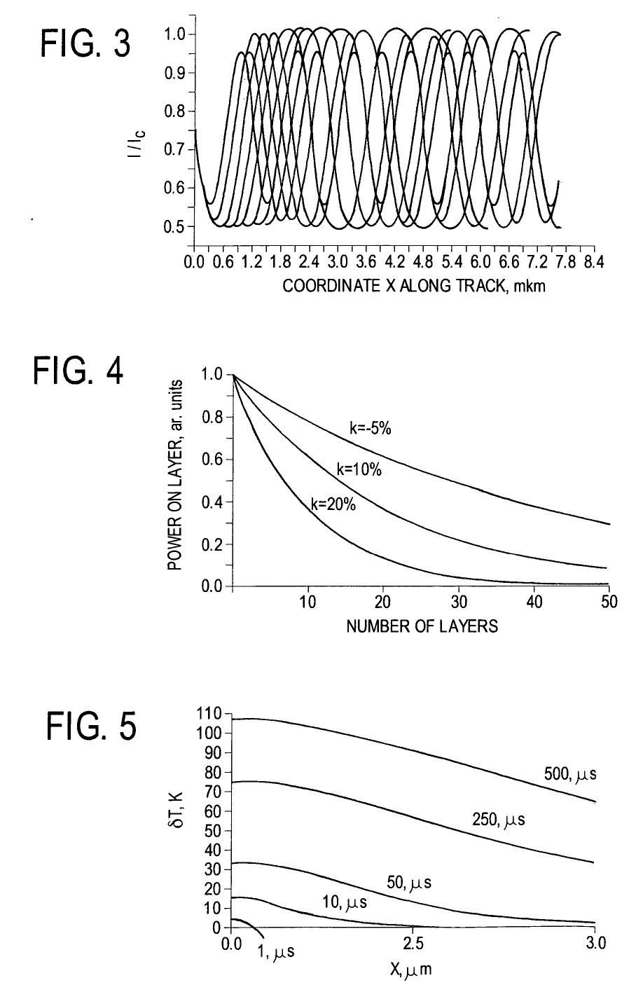

The calculations (see FIG. 3) confirm that recording quality in pits meets all CD/DVD standards.

Analysis shows that material with the mentioned non-linearity meets the main recording/reading criteria in CD/DVD standard and allows realizing a multilayer system. Thus, we have demonstrated a principal possibility of creating a multilayer fluorescent WORM on the example of a designed fluorescent dye.

Main Equations for WORM Operation.

The energetic fluorescence composition filling WORM grooves under the fixed parameters of laser radiation can be phenomenologically described by the following constants:

K—light absorption ratio of the information groove substance, γ—ratio of information surface covering with fluorescent substance, φ—coefficient, fixing the ratio between emanated fluorescent and absorbed power, the so called quantum fluorescence output. In the ‘thermal’ WORM quantum yield depends only on the radiation dose, absorbed by the composition.

Let us calculate the maximum possible heating during recording. First, we shall determine the laser beam power on the last MFD layer. If the absorption ratio in pits is k, and the filling ratio is γ, then for the n-layer we receive

$${P}_{n} = {P}_{0} {\sum }_{l = 1}^{n - 1} {( 1 - γ + ( 1 - 𝓀 ) γ )}^{l - 1} 𝓀 γ .$$

Let's assume k=5, 10, 20% and γ=0.5—for WORM in DVD standard. See below the power diagram on the last layer (controlled absorption) depending on the number of layers (FIG. 4).

The calculations show that, e.g., for a 10-layer system absorbed power on the last layer is 80%, 63% and 39% from the received power at the absorption coefficients in grooves 5%, 10% and 20% correspondingly. For a 40-layer system the absorbed power on the last layer is 37%, 14% and 2% from the received power. Thus, the power absorbed in the pit of a 10-layer system will be 4%, 6.3%, 7.8% for the mentioned absorption coefficient in pits; for a 40-layer system the last layer pit will absorb 1.85%, 1.4% and 0.4% of received power. For a 5-layer system, the power on the last layer is 90%, 81%, 66%, therefore the absorbed power is 4.5%, 8.1%, 13.2%.

As mentioned above, the groove warms up locally at recording, therefore thermal conductivity can be neglected. Local heating is determined by Poisson's equation without the term, fixing thermal conductivity:

$$\frac{ⅆ T ( 𝓍 , 𝓎 , 𝓏 )}{ⅆ t} 𝓀 I ( 𝓍 , 𝓎 , 𝓏 ) / ( 𝒽ρ {c}_{p} ) .$$

Here h is pit depth, ρ—density, cₚ—heat capacity of polycarbonate, I_{dbs}(x,y)—laser radiation intensity on the groove. At integration, we assume that time of the dye spot interaction is equal to the time of passing the distance between two zeros of the Bessel beam. Heating is estimated on the beam axis and on the groove surface, as we are looking for maximum value. For DVD parameters (width of groove—0.4 μm, beam diameter—1.22 μm) we get the average T≅kτ I₀/bρ cₚ, at that τ=430 μs (1×), 212 μs (2×), 108 μs (3×), 44 μs (10×); I₀=P/(0.3 μm²). P—power, absorbed in pit. For polycarbonate ρ cₚ=1.452 J/(sm³ K).

Hence for a minimal pit in DVD standard for the first speed (1.2 μm/μs) for h=0.5 μm we get:
T=1.97×10³×P[mW] k [K].

For a 5-layer disc heating of the last layer at initial power P=10 mW, k=5%, 10%, 20% we get:
T=887 K, 1595 K, 2600 K.

For 10 layers:
T=788 K, 1241 K, 1536 K.

At the same time for 10^{th} speed we get
T=91 K, 163 K, 266 K—for 5-layer system.
T=80 K, 127 K, 157 K—for 10-layer system.

Let's mark, that for CD parameters spot size is 1.73 times more, therefore the intensity is 3 times lower and maximum heating is also about 3 times lower.

Thus, the above calculations show the possibility to realize the highest possible temperatures for a 5-layer system with 20% absorption. It's necessary to consider, that we neglected thermal conductivity and thermal expansion of polycarbonate, but these effects are more essential for the pit shape and do not cause sufficient heat reduction in the beam center.

Noises, Arising During Unwanted Recording in Adjacent Layers

Beam diameter is much bigger on adjacent layers, in frames of geometrical optics its diameter can be estimated as

$$D / 2 = l \frac{NA}{\sqrt{1 - {NA}^{2}}} ,$$

where 1—distance from adjacent layer to the recorded layer, NA—numerical aperture of objective. At NA=0.65 and 1=350 μm D=600 μm. Thus, the heating process is stationary. We solve an equation for thermal conductivity to fix the temperature of maximum heating. Let us fix the necessary parameters: for polycarbonate disc ρ cₚ=1.452 J/(sm³ K), at laser power 10 mW, the intensity on the adjacent to recorded layer is 13 W/sm². In further calculations, we take porosity—ratio of pulses movement period to solitary signal duration—equal to 2, with consideration that the average power flow on the previous layer during recording is inversely proportional to this value. Constant thermal conductivity for polycarbonate is λ=0.1 W/m. We can neglect heat spreading across the information layer, therefore we have to solve a one-dimensional problem. Taking the average coefficient of absorption on the layer equal to 10% we get the following unbounded equation:

$$\frac{\partial T ( 𝓍 , t )}{\partial t} = - 6.88 \times {10}^{4} {µm}^{2} / s \frac{{\partial }^{2} T ( 𝓍 , t )}{\partial {x}^{2}} + 0.9 \times {10}^{4} K / s ,$$

where the second term in the right part (source of heating) differs from zero only on the groove. This equation has an analytical solution as an integral:

$$T ( 𝓍 , t ) = \frac{C}{2 a \sqrt{π t}} {\int }_{0}^{t} {\int }_{- b / 2}^{b / 2} {ⅇ}^{- \frac{{( 𝓍 - ξ )}^{2}}{4 {a}^{2} ( t - τ )}} ⅆ ξ ⅆ τ ,$$

where—source function—in this case is equal to 0.9×10⁴ K/s, a²—factor at the second space derivative—is in this case equal to 6.88×10⁴ μm²/s, h—depth of groove (in this case 0.5 μm).

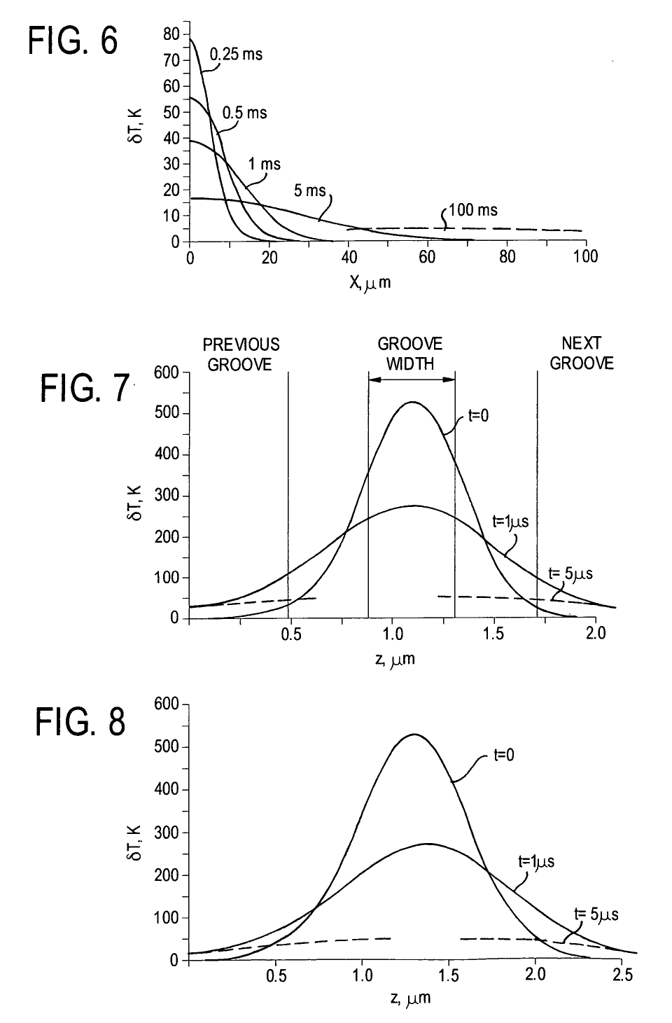

FIG. 5 demonstrates calculations of adjacent layer heating dependence on exposure period. The origin of the coordinates is in the middle of the pit. At the first speed, the recording beam passes 600 μm in 500 μs. Averaging intensity distribution along the beam profile, we get the effective interaction time about 250 μs. The calculation shows that during this time period the layer adjacent to the recorded one is warmed up approximately on 80 K. Pit cooling process is also of interest (see FIG. 6). Turnover time of the inside groove of 5″ disc is about 125 ms; according to calculations, this time is enough for establishing stationary temperature distribution in a multilayer WORM.

Reading Radiation Interaction with the Recorded Pits.

All the main correlations, determining reading laser influence on recorded pits on CD, are also valid for MFD-ROM. The specific is the following: first, the pits' shape is no more strictly rectangular, but represent continuously spreaded derivations of smooth shape, determined by spatial characteristics of the recording beam; secondly, during reading process, undesirable recording is inevitable.

To solve these problems, we are to calculate three-dimensional dynamic equation for heating at recording and reading. Assuming independence of absorption, heat capacity and thermal conductivity ratios of polycarbonate on temperature values, time-space distribution of temperature can be described by the following four-dimensional integral:

$$T ( 𝓍 , 𝓎 , 𝓏 , t ) = {C ( \frac{1}{2 a \sqrt{π t}} )}^{3} {\int }_{0}^{dt} {\int }_{- b / 2}^{b / 2} {\int }_{- l / 2}^{l / 2} {\int }_{- ∞}^{∞} A ( ξ , , η ) {ⅇ}^{- \frac{{( 𝓍 - ξ )}^{2} + {( 𝓎 - )}^{2} + {( z - η )}^{2}}{4 {a}^{2} ( t - τ )}} ⅆ ξ ⅆ ⅆ η ⅆ τ ,$$

where C is the source function, dt—pulse duration, l—groove width, A(ξ,ç,η)—dimensionless function, describing the focused laser beam intensity distribution. Assuming Bessel beam shape in DVD standard, 20% absorption, 10 mW laser power and 0.45 μs impulse, we receive the maximum value of heating inside pit equal to 525 K. Evidently interesting is the kinetics of pit cooling within the information layer. See FIG. 7 for temperature distribution in the information layer across the groove in different moments.

The calculations show three important results:
1. Maximum heating of adjacent grooves is an order less than of the recorded layer. Thus, even without knowledge of the non-linear mechanism we can neglect the small destruction of adjacent tracks at recording.
2. The pit is cooled in microseconds, therefore chemical reactions' rate during heating of the dye should be not less than 1 μs, either the reaction should be initiated during short time and run as long as possible without maintenance of temperature.
3. Heat regime can be used for recording on fluorescent photosensitive multilayer optical WORM disc.

Based on the curves on FIG. 8 and non-linear characteristics of a substance (of FIG. 1—type), we can conclude on the form of pit and its contrast (the half-width is 0.8 μm).

The comparison of the above calculations with evaluations, made disregarding thermal conductivity, show that the real maximum heating is several times less, namely, under the mentioned parameters it makes 525 K. However, applying the obtained figures to a multilayer system we get the following maximum heating on the last layer: for 5-layer disc—246 K; for a 10-layer disc—204 K; for a 40-layer disc—only 10 K. The same way at 10% absorption rate we obtain 213 K, 165 K and 37 K. At 5% absorption rate: 118K, 105 K, 48 K.

The same results are valid for the reading process, temperature distribution is the same in all time periods, the temperature scale drops down in as much orders as the laser radiation power.

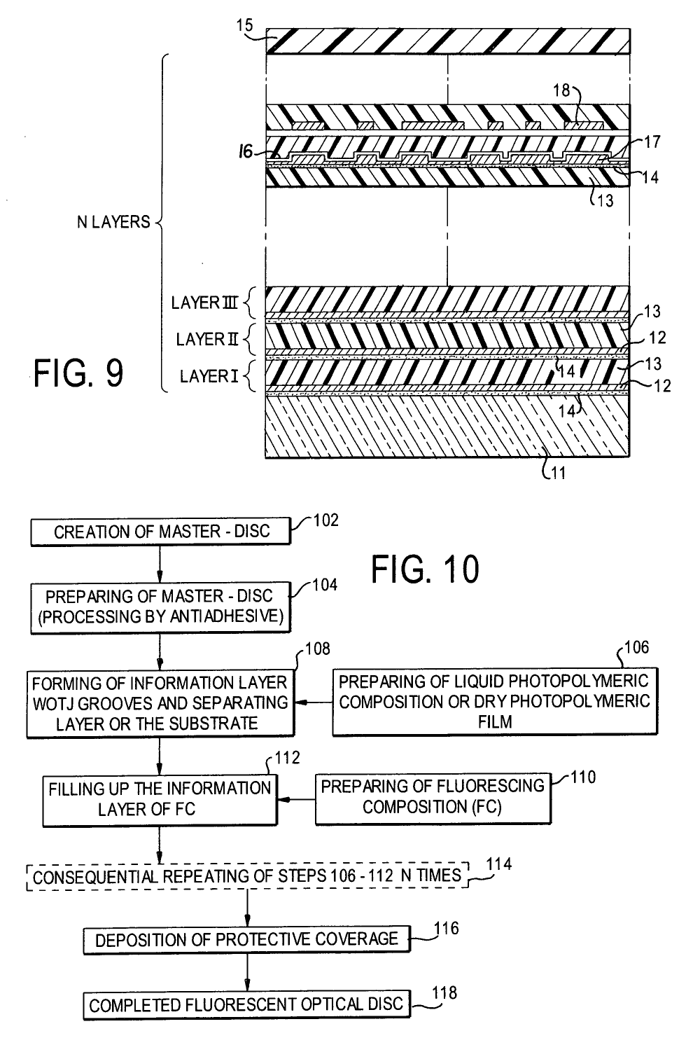

FIG. 9 shows schematically a fluorescent optical disc according to the preferred embodiment. Fluorescent optical disc 10 includes a transparent protective substrate 11 and consistently located one above the other information layers 12, divided by polymer layers 13 and assembled in single block by gluing layers 14. Lacquer cover 15 protects fluorescent disc 10 from mechanical damages and aggressive media.

Substrate 11 is transparent to visible light. It represents a flat plane from glass, polycarbonate, polymethylmetacrilate or other polymer material, 0.6 or 1.2 mm thick and 120 mm in diameter.

Protective layer 15 is obtained by deposition and drying of resin solution or by polymer film lamination with adhesive.

Intermediate layers are 10-300 μm thick.

Protective layer 15, intermediate—13, adhesive—14 and information—12 have reflection ratios at reading and fluorescence wavelengths close to the refraction index of substrate 11. It is preferable to remove light reflection on layers' boundaries. There several ways to obtain intermediate layers.

Polymer solution pouring on the optical disc with future solvent evaporation.

Lamination of an isotropic polymer film with an adhesive on the optical disk.

Use of UV-cured liquid or “dry film” photo-polymerized compositions is the most interesting for obtaining intermediate layers.

Technological Process of Obtaining Thin Intermediate Layers.

As you can see on FIG. 9, spatially-divided data layers can be fully fluorescent (layer 16), if fluorescent substance fills both pits or grooves (WORM) 17, and the space above them. In this case, absorption and fluorescence in pits or grooves will have higher intensity.

In another variant data layers have “islands”—only pits and grooves 18 are filled with fluorescent substance, providing higher contrast at reading.

As stated above, data signal value from FMD i-layer sufficiently depends on absorption ratios' distribution in pits and grooves of FMD different layers. Thus, ratios' distribution requires optimization. At the given distribution of absorption ratios between the layers fluorescent data signals from pits will have the same distribution of intensity.

At that, a necessary optimization requirement is the equality of intensity of all data signals, irrespective of their location within the disc.

The proposed method is based on consistent layer-by-layer obtaining of information layers with micro-relief of pits or grooves, filling ROM, WORM or RW micro-relief with fluorescent material and a multilayer structure assembly.

Various methods, applied for mass duplication of relief optical elements like CD-ROM, relief holograms and diffraction gratings, etc. can be used to obtain layers with micro-relief. The use of liquid photo-polymerized composition (PhPC) or dry photo-polymerized films, applied in microelectronics, is the most preferable as a relief-base material. FIG. 10 shows a flow chart of the steps used in fluorescent WORM disc manufacturing. In step 102, the master disc is created. In step 104, the master disc is prepared by processing it with an anti-adhesive material. In step 106, a liquid photopolymeric composition or a dry photopolymeric film is prepared. In step 108, the information layer is formed using the photopolymeric composition of film, and the grooves if any are formed therein. The separating layer is also formed. A fluorescing composition is formed in step 110 and filled into the information layer in step 112. To form a multilayer disk, steps 106-112 are repeated as many times as necessary in step 114. The protective covering is deposited in step 116, resulting in a completed fluorescent optical disk in step 118.

An important problem during FMD production is optimization of pits' and grooves' filling technology in every information layer. It shall provide increasing of contrast (the relation of signals from fluorescence centers in pits and background signal from the layer surface between pits).

The technical solutions, utilizing highly energetic compounds for optical data storage is described in U.S. Pat. No. 4,334,008. That patent teaches a photo-sensitive polymer composition on the basis of polynitroether (i.e., nitrocellulose) and aromatic amino, capable of forming colored light-absorbing photoproducts under radiation. However, this composition is sensitive only to the UV-spectrum. U.S. Pat. No. 4,622,284 describes a composition on the basis of heavy metal acids, dispersed in an inert binding agent, containing a light absorbing agent. However, in this case the data recording medium is a light diffusing dispersion of a solid state in an inert binding agent, which sufficiently reduces spatial resolution at data recording and does not allow three-dimensional information structures.

Due to high optical transparency of layers and multilayer disc structure, the proposed technical solution allows sufficient increase of data capacity with as high recording rate.

It is also possible to combine several functions in one component (i.e., heat-sensitive power-consuming substance serves as absorber, etc.).

Such composition shall meet the following requirements: a) both fluorescent probe and light-absorber shall possess sufficient absorption on the laser wavelength; b) light-absorber and the probe shall be chemically inert, while their quantum yield during photo-degradation at low light intensity shall be less than 10⁻⁷; c) heat-sensitive power-consuming substance (or a composition of such substances, including high-molecular) shall be absolutely stable to possible fluctuations in media temperature (from 40° C. to +50° C.) and to brief local heating of disc under reading laser radiation; d) to achieve high recording rates, the heat-sensitive substance shall have high power consumption; e) the dye shall have high migration stability, i.e. due to its covalent sewing to the polymer matrix.

A photosensitive information layer can be a stratified polymer aggregate (multilayer structure), while its intermediate layers can have both low-, or high-molecular nature. For example, a stratified polymer aggregate, containing light-absorbing substance in an inert polymer matrix and a polymer layer, consisting of fluorescent dye and power-consuming substance, or a sprayed low-molecular light-absorbing dye (i.e., phthalocyanine) and a polymer layer, consisting of fluorescent dye and power-consuming substance.

Photosensitive information layers can contain co-polymers with covalently connected functional groups in their main or side chains, which provide the necessary properties, such as fluorescence, power consumption, light absorption, etc., thus increasing temporal stability of the layers' optical and other physical characteristics, increasing data recording rate and improving information layers' output characteristics (i.e., contrast). This functional groups can be implemented into co-polymer with forming covalent connections during its synthesis from relevant monomers (i.e., monomers with vinyl groups) or by similar transformation of polymers, containing reactive fragments (i.e., cyclic anhydride, glycydil, etc.) To obtain information layers from oligomers and low-molecular monomers, they are polymerized together with the functional reactive groups of the above range of low-molecular compounds, which can covalently contact the polymer matrix with net structure.

Use of pH-Dependent Dyes as WORM Information-Carriers.

Non-linear response of the information media can be reached using a pH-dependent dye as absorber, fluorescence extinguisher or the very fluorescent substance. Local pH change is achieved by heat-sensitive proton generator. Increase of non-linearity order requires stronger bases, than the dye. Laser radiation intensity increase causes H⁺ concentration increase due to proton generator decomposition. However, these protons react with the hard base up to some certain limit, when they start reacting with the dye, causing sufficient modulation of spectrum (including luminescent) characteristics. Such a system was demonstrated on the example of forming a-phenyl methane dye from its leuco form under its radiation with different light pulses.

Wavelength λ=820 nm, duration 2.5 μs. Radiation is absorbed with squarilen dye. Optical density of polymer film at 820 nm=1.1. (patent U.S. Pat. No. 05,667,943)

At heating the film with laser beam, proton generator (3,4-disulbstituted-cyclobut-3-ene-1,2-dione) decomposes, and the formed acid reacts with the leuco form, creating a TΦK colored form. This process can be used for getting fluorescent response due to energy transfer from fluorescent dye to the colored form TΦK.

System Parameters:

1) Non-linearity degree −5-6 (at writing and reading power difference in 10 times and at similar rates of recording and reading, the system allows. 10⁵-10⁶ reading cycles).

2) Sensitivity (1 nW on 1 μm²) is enough for recording at rate 0.1-1 μs.

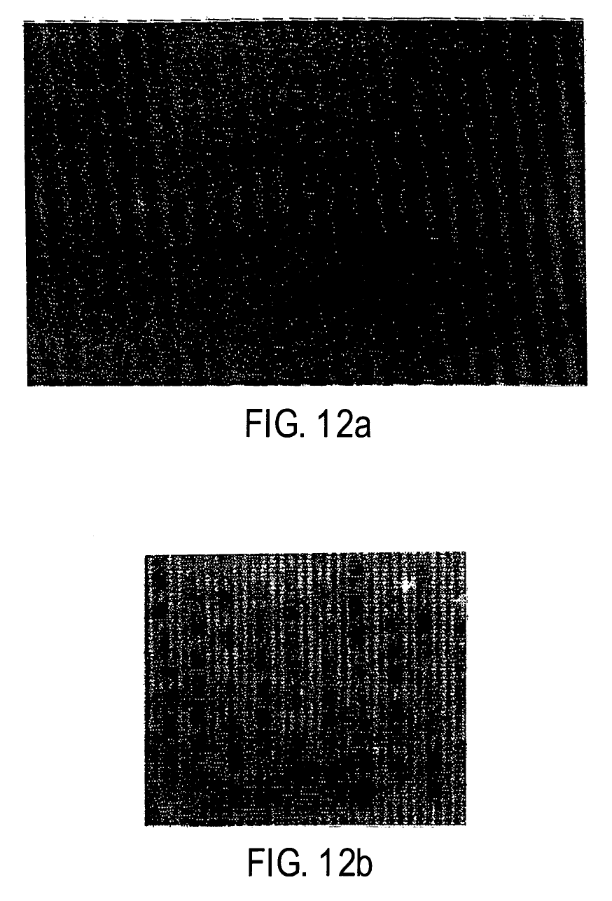

Data is recorded by diode laser up to 20 mW, with the beam focused in spot sized <1.6 μm. See FIG. 11 for a schematic diagram of a writing-reading device. As already described, the disc 10 includes photosensitive layers 12 and inert layers 13, 14. In the, writing-reading device 200, a laser diode 202 produces an incident light beam IL which passes through a dichroic beamsplitter 204 and is focused by a lens 206 onto the disc 10. In reading mode, the spot on the disc onto which the lens 206 focuses the incident light IL fluoresces with a wavelength different from that of the incident light IL. The resulting fluorescent light FL passes through the lens 206 and the beamsplitter 204, the latter of which separates the light beams IL and FL by their wavelengths, and directs the light FL onto a detector 208 for reproducing information. In writing mode, the laser diode 202 is driven at a higher power, as will be explained in further detail below.

Local temperature increase in the spot initiates exothermal reaction of heat-sensitive component decomposition and appearance of decomposition products. Chemical reaction of power-consuming substance decomposition products with the dyes causes destruction of both the fluorescent probe and the absorber. Thus, laser radiation causes irreversible modulation of optical parameters in the effected spot, i.e. increase or decrease of fluorescence intensity. In this connection we propose 2 types of information media:

1. If the absorber does not extinguish fluorescence, it causes decrease of fluorescence intensity due to decomposition of fluorescent probe or formation of specific fluorescence extinguishers.

2. If the absorber extinguishes fluorescence of the probe, hence if it decomposes quicker than the fluorescent substance, that we can receive increase of fluorescent intensity.

The power-consuming, aggregates cans also serve as light-consumers and fluorescence extinguishers. It makes the extinguisher decomposition the most effective. As the concentration of such power-consuming light-absorber & extinguisher is limited (due to limited values of light consuming in the information layer), we propose introducing the second power-consuming component with no absorption in the laser radiation spectrum, to achieve the necessary power consumption values in the media.

Reading in such a system is made by registering fluorescence, excited by radiation from the same laser diode, which makes recording. Radiation intensity at reading is 10-15 times less than at recording, that allows the necessary (over 10⁵) number of reading cycles without changing optical parameters of the information-carrier. FIGS. 12A and 12B show microphotos of fluorescent grooves and recorded pits, respectively, in a fluorescent optical disc.

### Examples of Photosensitive Compositions for WORM

Example 1. The information layer consists of fluorescent substance, i.e. styryle 9M (2-(6-(4-dimethylaminophenyl)-2,4-neopentylene-1,3,5-hexatrienyl)-3 -methyl-benzotriazolium Perchlorate), light-absorbing substance, i.e. malachite green, and power-consuming, power-amplifying (explosive) substance, like 5-aminotetrazolum in polyvinylbutirate. Such system offers recording time below 0.5 μs at laser radiation power on the disc 7 mW. At that the recorded spot is not less than 0.8 μm at contrast over 30% with the beam spot of 1.2 μm.

Example 2. The information layer consists of light-absorbing sub-layer from polystyrene with malachite green, coated with polymer film from polyvinylbutiral with fluorescent probe—styryle 9M and power-consuming substance—tetrazolophenylthiazolum.

Example 3. Polymer composition for the information layer consists of the power-consuming product, obtained by analog to polymerization transformation of high-molecular compound and power-consuming substance with reactive group. Product of condensation of styrene co-polymer and maleinic anhydride (sthyromate) with 5-aminotetrazolium, fluorescent substance—styryl 9M and light-absorbing substance—malachite green.

Example 4. Polymer composition for the information layer consists of the power-consuming product, obtained by analog to polymerization transformation of high-molecular compound and power-consuming substance with reactive group. Polymer product of polyvinylbutiralfurfurene and N-tetrazolylmaleimide, fluorescent substance—rhodamine 800 and light-absorbing substance—malachite green.

Example 5. Composition consisting of: 1) two or more polymer materials, one of them being power-consuming, 2) light-absorber, (not) acting also as power-consuming substance, and 3) fluorescent probe, (not) acting also as power-consuming substance. For example, compound of polystyrene and the polymer, obtained by co-polymerization of styrene and N-tetrazolylmaleimid with the components of tetranythrotetrazole blue and schiff based dye 1H-pyrazolo[1,5-b][1,2,4]triazole.

Example 6. Polymer composition consisting of: 1) fluorescent substance, 2) energetic substance—light-absorber, also suppressing fluorescence, and 3) energetic substance substance. For example, complex of nickel with ligands 2-(1N-methyl)benzimidazolyl-1′azo-2′-phenylaminnaphtyl in compound with oxazyne 1 and tetrazolophenyltiazolum in polystyrene matrix.

While various preferred embodiments have been set forth above in detail, those skilled in the art who have reviewed the above disclosure will readily appreciate that other embodiments can be realized within the scope of the present invention. For example, the exact number of layers and their thicknesses is illustrative rather than limiting. Therefore, the present invention should be construed as limited only by the appended claims.

1. Multilayer data-registering optical disc, comprising:
a transparent substrate;
a plurality of information layers on the transparent substrate, said information layers being spatially divided from one another by polymer layers and assembled with adhesive layers; and
a protective layer covering the plurality of information layers;
each of said plurality of information layers exhibiting a nonlinear response to a recording light beam.

2. Optical disc according to claim 1, wherein the disc substrate, intermediate and adhesive layers are transparent to reading radiation.

3. Optical disc according to claim 1, wherein intermediate layers are 10-300 μm thick.

4. Optical disc according to claim 1, wherein all layers have similar refractive index.

5. Optical disc according to claim 1, wherein the information layers contain spiral grooves.

6. Optical disc according to claim 5, wherein the information layers define planes with a photosensitive substance applied continuously over said planes.

7. Optical disc according to claim 6, wherein a surface of each of the information layers is flooded with a solid layer of photosensitive substance, so that a portion of the solid layer above the grooves is thicker than a portion of the solid layer which is not above the grooves.

8. Optical disc according to claim 6, wherein information surface represents spatially divided photosensitive grooves on non-photosensitive background.

9. Optical disc according to claim 1, wherein the information layers are fluorescent WORM layers.

10. Optical disc according to claim 9, wherein the information layers comprise a substance whose molecular structure is capable of changing due to thermochemical reactions.

11. Optical disc according to claim 9, wherein the fluorescent WORM layers have an at least fifth-order non-linear response to the recording light beam.

12. Optical disc according to claim 9, wherein the fluorescent WORM layers have threshold response to the recording light beam.

13. Optical disc according to claim 9, wherein the fluorescent WORM layers respond to the recording light beam by extinguishing fluorescence.

14. Optical disc according to claim 9, wherein the fluorescent WORM layers respond to the recording light beam by increasing fluorescence.

15. Photosensitive composition for WORM layer, comprising:
one or more substances and their products after thermochemical reaction, capable to change their fluorescence under recording radiation;
one or more substances, incapable to fluoresce under recording radiation and serving as absorber of recording radiations
a heat-sensitive power-consuming substance, capable to thermochemically react with fluorescent substance or its predecessors;
a polymer matrix, containing all ingredients of the composition on molecular level;
an inhibitor of thermochemical response in darkness; and
organic solvents, providing solution of all dry composition ingredients.

16. Composition according to claim 15, wherein the fluorescent substance or non-fluorescent substances (absorbers) have photodegradation quantum yield at low light intensity below 10⁻⁷.

17. Composition according to claim 15, wherein sthyril 9M. (2-(6-(4-dimethylaminophenyl)-2,4-neopentylene-1,3,5 -hexatrienyl)-3-methyl-benzotriazolium Perchlorate) is used as fluorescent substance.

18. Composition according to claim 15, wherein Rhodamin 800 is used as fluorescent substance.

19. Composition according to claim 15, wherein substances, providing composition stability at −40-+50° C. serve as inhibitors.

20. Composition according to claim 15, wherein substances, providing appearance of free radicals at laser radiation absorption and layer heating up to 150-200° C. serve for power consumption.

21. Composition according to claim 15, wherein tetrazolophenylthiazolum serves for power consumption.

22. Composition according to claim 15, wherein polymers or their mixtures of polyvinilbutiral type serve as polymeric connector.

23. Composition according to claim 15, wherein malachite green serves as photo absorbent.

24. Composition according to claim 15, consisting of co-polymers, containing covalently connected functional groups in main or side chains, providing fluorescent, light-absorbing and other functions.

25. Photosensitive composition according to claim 15, wherein pH-dependent dyes serve as fluorescence absorbers.

26. A device for writing data to and reading data from a fluorescent medium, the device comprising:
a light source for generating a first light beam for writing the data and a second light beam for reading the data, the first and second light beams having a common wavelength which excites fluorescence in the medium to produce fluorescent light having a fluorescent wavelength different from the common wavelength;
a lens, disposed in a path of the first light beam between the light source and the medium, for focusing the first and second light beams onto the medium and for receiving the fluorescent light from the medium; and
a detector, disposed in a path of the second light beam, for detecting the second light beam and reproducing the data from the second light beam.

27. A device as in claim 26, further comprising a wavelength-dependent beam splitter, disposed in the path of the second light beam between the medium and the detector, for separating the paths of the first and second light beams in accordance with their wavelengths.

28. A device as in claim 27, wherein the beam splitter is disposed in the path of the second light between the lens and the detector.

29. A device as in claim 26, wherein the detector reproduces the data by detecting a difference in an optical parameter between a spot having the data recorded thereon and areas around the spot.

30. A device as in claim 29, wherein the optical parameter is fluorescence.

31. A method of recording information, the method comprising:
(a) providing a multilayer medium comprising a plurality of information layers, each of the plurality of information layers comprising a photosensitive material having a nonlinear response to a recording light beam;
(b) focusing said recording light beam onto a spot on one of the information layers such that an intensity of the recording light beam on said one of the information layers is sufficient to record the information in said one of the information layers, while an intensity of the recording light beam on adjacent ones of the information layers is not sufficient to record the information; and
(c) recording the information on said one of the information layers using said recording light beam.

32. The method of claim 31, wherein the nonlinear response is an at least fifth order nonlinear response.

33. The method of claim 31, wherein the nonlinear response is a threshold nonlinear response.

34. The method of claim 31, wherein step (c) comprises extinguishing a fluorescence in the spot.

35. The method of claim 31, wherein step (c) comprises increasing a fluorescence in the spot.

36. The method of claim 31, wherein step (c) is performed through a thermochemical reaction.

37. The optical disc according to claim 9, wherein the information layers comprise a substance whose molecular structure is capable of changing due to local pH changes.

38. The photosensitive composition for WORM layer of claim 15, wherein the change in fluorescence is due to local pH changes.

39. The device of claim 26, wherein the fluorescent light is produced by local pH changes.

40. The method of claim 31, wherein the information layers comprise a substance whose molecular structure is capable of changing due to local pH changes.
